(19) United States
(12) Patent Application Publication
(10) Pub. No.: US 2024/0144612 A1
(43) Pub. Date: May 2, 2024

(54) VEHICLE AR DISPLAY DEVICE AND AR SERVICE PLATFORM

(71) Applicant: ANYRACTIVE. CO., LTD., Seoul (KR)

(72) Inventor: Sung Hyun LIM, Seoul (KR)

(73) Assignee: ANYRACTIVE. CO., LTD., Seoul (KR)

(21) Appl. No.: 18/404,644

(22) Filed: Jan. 4, 2024

Related U.S. Application Data
(63) Continuation of application No. PCT/KR2022/009636, filed on Jul. 5, 2022.

(30) Foreign Application Priority Data
Jul. 5, 2021 (KR) 10-2021-0087616
Oct. 5, 2021 (KR) 10-2021-0131638

(51) Int. Cl. G06T 19/00; G01S 19/01; G06T 7/70; G06V 10/25; G06V 20/58

(52) U.S. Cl. CPC G06T 19/006; G01S 19/01; G06T 7/70; G06V 10/25; G06V 20/58; G06T 2207/10028

(57) ABSTRACT

The present disclosure relates to a vehicle AR display device and method, and an AR service platform and, more particularly, to a method for outputting additional information of an object photographed by a camera mounted on a moving vehicle to match the object. In this regard, the present disclosure provides an AR service platform system comprising: a relay terminal that calculates the location, direction, or position of a vehicle by using information collected from a positioning sensor or a camera, extracts a POI object included in an image obtained from the camera, and controls additional information regarding the extracted POI object to be output to match the POI object; and a main (AR) server that is connected to the relay terminal, extracts the additional information regarding the POI object, which is included in the information collected from the camera, and provides the additional information to the relay terminal.

### CROSS-REFERENCE TO RELATED APPLICATIONS

This application is a continuation application of PCT international application PCT/KR2022/009636 filed on Jul. 5, 2022, which claims the priorities of Korean Patent Application No. 10-2021-0087616 filed Jul. 5, 2021, and Korean Patent Application No. 10-2021-0131638 filed Oct. 5, 2021, which are incorporated herein by reference in their entireties.

### TECHNICAL FIELD

The present disclosure relates to vehicle AR display devices and methods and AR service platforms and, more particularly, to methods of outputting additional information of object photographed by a camera mounted on a vehicle such that the additional information is matched to the objects.

### BACKGROUND

Virtual Reality (VR) technology provides objects, backgrounds, or the like in the real world through Computer Graphic (CG) images and Augmented Reality (AR) technology provides virtual CG images together on actual object images, and Mixed Reality (MR) technology is a computer graphic technology that mixes, combines, and provides virtual objects with the real world. VR, AR, and MR, etc. described above are all also simply called extended reality ( )R) technology.

AR technology is a method of overlaying virtual digital images on the rear world. AR is discriminated from VR, which shows only graphic images with eyes covered, in that users can substantially see the real world through their eyes. Unlike VR devices that can be used only indoors, it is possible to use AR glasses like glasses while walking, so AR glasses can be used in more various ways.

Recently, various technologies using point of interests (POIs) are coming out in accordance with the demands of customers in the navigation service for vehicles. Technologies that recognize the actual external shapes of POIs from an image and provide POI shape information when a user drives with AR glasses on are also coming out. It is possible to match and show POI shapes on an actual image as an AR image in various AR-based services.

However, the related art has a problem of deterioration of performance when matching an AR image and a POI region in a moving image. In detail, an AR image is displayed at a position that is not a POI region due to low accuracy of the AR image and the POI region, so users feel uncomfortable due to this phenomenon.

To explain further, a predetermined buffer frame is required for positioning of Simultaneous Localization and Mapping (SLAM) coordinates, and when a predetermined buffer frame is not satisfied, immediate loading is not achieved. Further, when the field of vision of a camera is poor, mapping itself is not achieved.

In addition, when there are a lot of point cloud metadata, delays frequently occur, and accordingly, predetermined time is required when matching an object and additional information. In particular, since it is difficult to make point clouds in large quantity, there is a problem that the long update cycle and the production period are long.

### BRIEF SUMMARY

An objective of the present disclosure is to propose an AR display device for a moving vehicle and an AR engine for implementing the AR display device.

Another objective of the present disclosure is to propose a method of accurately matching additional information to an object of which the coordinates depend on the posture of a moving vehicle.

Another objective of the present disclosure is to propose a method of accurately matching additional information to an object using vehicle-related information that is collected from a device in a moving vehicle.

To this end, the present disclosure solves a buffering problem based on an image using a minimum recognition method that uses not only a camera image and interworking of various items of sensor information of a vehicle, but also high-accuracy positioning such as Real-time kinematic (RTK) without a sensor in a vehicle and AI-based surrounding recognition and major object analysis (roads, sidewalks, signals, characters, etc.), immediately updates a location when a field of vision is poor, and accurately and quickly receives and maps POI data using a preloading method considering a movement direction.

The vehicle AR display device and the AR service platform according to the present disclosure can perform precise positioning and create a map for autonomous driving composed of minimum metadata using a vehicle that has been being used without an exclusive vehicle for precision positioning or a 3D point cloud. Further, since when a transportation means is a car and is moved every day, a map is updated every day, whereby it is possible to secure reliability of data.

In particular, when the posture of a moving vehicle is changed and even though locations of objects relative to the vehicle are changed, the present disclosure calculates the changed locations of the objects and outputs additional information such that the additional information is accurately matched to the objects, thereby being able to increase reliability for users.

Further, the present disclosure determines the posture of a vehicle using at least two or more items of vehicle-related information such as the RTK, the Global Positioning System (GPS), and camera images, thereby being able to increase reliability of data.

### BRIEF DESCRIPTION OF DRAWINGS

FIG. 1 shows an example AR display system using an information output device and a camera according to an embodiment of the present disclosure.

FIG. 2 shows an example configuration of an Augmented Reality (AR) engine module according to an embodiment of the present disclosure.

FIG. 3 shows an example configuration of an AR platform according to an embodiment of the present disclosure.

FIG. 4 is an example configuration diagram of an AR service system according to an embodiment of the present disclosure.

FIG. 5 shows an example configuration of a relay terminal according to an embodiment of the disclosure.

FIG. 6 shows an example configuration of an AR main server according to an embodiment of the pre sent disclosure.

### DETAILED DESCRIPTION

Aspects of the present disclosure that were described above and will be added will be made clearer through exemplary embodiments that are described with reference to the accompanying drawings. Hereafter, such embodiments of the present disclosure are described in detail so that those skilled in the art can easily understand and achieve the present disclosure.

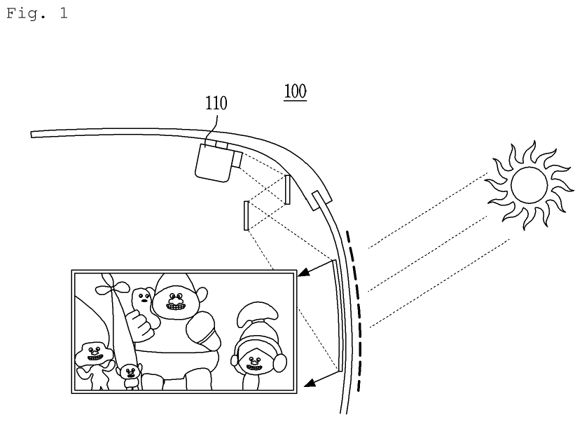

FIG. 1 shows an AR display system using an information output device and a camera according to an embodiment of the present disclosure. Hereafter, an AR display system using an information output device and a camera according to an embodiment of the present disclosure is briefly described with reference to FIG. 1.

According to FIG. 1, an AR display system 100 may include an information output device that outputs additional information on a window, a camera, a relay terminal, and an AR main server. Of course, components may be included in the AR display system proposed herein other than the components described above.

The camera (not shown) is mounted on the outer side of a transportation means and photographs the outside of the transportation means. In relation to the present disclosure, the transportation means is a vehicle that can be moved such as a car, a bus, and a train. For example, the camera is installed on the outer side of a vehicle and photographs the outside of the vehicle that is moved. Of course, the camera may be installed inside a vehicle, but even in this case, it is preferable to take pictures of the outside of the vehicle.

Various POI objects such as building including a bank, a restaurant, etc., historic sites, parks, etc. exist outside the vehicle moving on a road. The camera takes an image of the outside of the vehicle that is moving. The camera transmits the taken outside image to the relay terminal. The relay terminal is positioned inside the vehicle and transmits the outside image of the vehicle to the AR main server.

The relay terminal is connected to the AR main server, the camera, and the information output device 110. The relay terminal receives an image from the camera. The relay terminal transmits the image received from the camera to the AR main server. The relay terminal provides information received from the AR main server to the information output device. In relation to the present disclosure, the relay terminal is provided with an image, which includes additional information of Point of Interest (POI) objects included in an image taken by the camera, from the AR main server and provides the image to the information output device. In relation to the present disclosure, the relay terminal is provided with and stores, in advance, additional information of POI objects from the AR main server, matches the additional information of the pre-stored POI objects to the image taken by the camera, and provides the image to the information output device.

The information output device 110 outputs the image including the additional information provided from the relay terminal. In relation to the present disclosure, the information output device outputs an image on the window of a vehicle such that the image is matched to POI objects positioned outside the vehicle.

The AR main server (not shown) is provided with an image taken by the camera from the relay server and extracts POI objects and additional information of the POI objects from the provided image. To this end, the AR main server is connected to the database DB and extracts POI objects and additional information of the POI objects, which will be provided to the relay terminal, from the image provided from the relay terminal and information stored in the database. In relation to the present disclosure, the information output device and the relay terminal may be configured as a single unit.

In relation to the present disclosure, the AR main server extracts and provides additional information of POI objects in advance to the relay terminal by estimating the movement path of the vehicle before receiving an image from the relay terminal. To this end, the AR main server may store various items of information about movement paths of the vehicle.

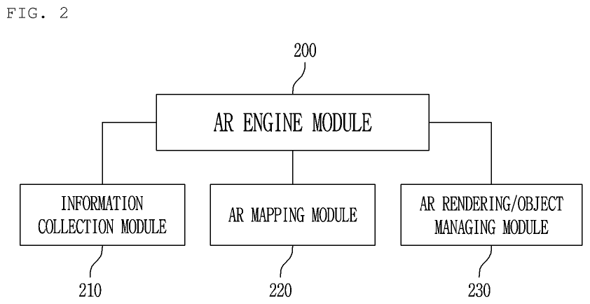

FIG. 2 shows the configuration of an Augmented Reality (AR) engine module according to an embodiment of the present disclosure. Hereafter, the configuration of an AR engine module according to an embodiment of the present disclosure is described in detail with reference to FIG. 2.

In relation to the present disclosure, the AR engine module 200 includes an information collection module 210, an AR mapping module 220, and an AR rendering/object managing module 230. Of course, components other than the components described above may be included in the AR engine module 200 described in the present disclosure and the AR engine module is installed at least one server of the relay terminal or the AR main server.

The information collection module 210 collects the location of the vehicle and a moving surrounding image. The information collection module 210 performs the function of detecting, classifying, or separating POI objects on the basis of artificial intelligence-machine learning (AI-ML) in an image taken using a camera mounted on the vehicle. Further, the information collection module 210 implements an Advanced Driver Assistance System (ADAS) using the RTK, GPS, and a plurality of sensors mounted on the vehicle such as a gyro sensor or a Lidar sensor. The ADAS includes various functions such as Forward Collision-Avoidance Assist (FCA) and Lane Departure Warning (LDW).

Sensing objects using a radar is a manner that senses objects by measuring time taken until a transmitted radio wave is received. Radars are applied to various fields such as blind spot sensing, forward collision warning, lane change assistant, and automatic emergency braking.

A lidar sensor is operated in a similar principle to radars, but measures physical properties such as the distance, speed, and shape of an object to be measured on the basis of time and strength of a Lidar reflecting or returning, variation of a frequency, and variation of a polarization state by emitting a lidar sensor to create a high-resolution 3D image of a surrounding environment.

In addition, according to the present disclosure, a camera is installed inside a vehicle and the gaze of a user is tracked using the installed camera. That is, the information collection module tracks the gaze of a user by photographing the eyes of a user using the camera installed in the vehicle and analyzing the photographed eyes of the user.

The AR mapping module 220 converts 2D location information, such as the features of a road (a road surface, lanes), traffic signs, and traffic signals into coordinates in a 3D space using a space analysis technique of a camera. This operation will be described below in detail.

The AR rendering/object managing module 230 performs real-time rendering to display various items of AR information on a screen in real time. That is, the display proposed in the present disclosure may be implemented in various types, and accordingly, rendering is performed in accordance with the types of display intended to be implemented. For example, when it is wanted to output an AR image using a beam projector, rendering is performed such that the AR image can be output from the beam projector.

The AR engine platform 200 may include computers including, for example, a Central Processing Unit (CPU), a Read Only Memory (ROM), a Random Access Memory (RAM), an input/output interface, a storage device such as a hard disk, and the like. Thus, for example, some or all of the functions of the information collection module 310, the AR mapping module 320, and the AR rendering/object managing module 330 can be achieved by reading the various processing programs stored in the ROM or the storage device into the RAM and executing the programs in the CPU

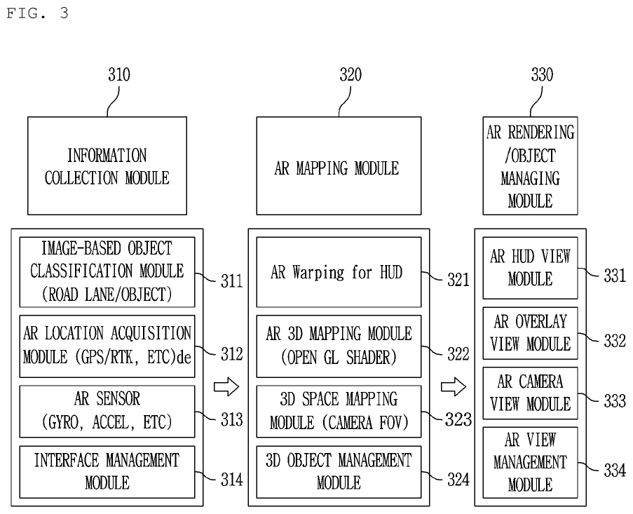

FIG. 3 shows an example configuration of the AR engine platform 200 according to an embodiment of the present disclosure. Hereafter, the configuration of an AR engine platform according to an embodiment of the present disclosure is described in detail with reference to FIG. 3. As described above, the AR platform is configured and installed in at least any one server of the relay terminal or the AR main server.

In order to output additional information that is matched to a taken POI object image, as described above, the information collection module 310, the AR mapping module 320, and the AR rendering/object managing module 330 may be p as described below.

The information collection module 310 includes AR classification module 311, an AR location module 312, an AR sensor, and a sensor signal/data interface manager module 314.

The AR classification module 311 performs the function of detecting and classifying objects such as a lane, a traffic sign, and a traffic signal. The AR location module 312 calculates the current location of a vehicle using the GPS, RTK, etc.

The AR sensor 313 includes a gyro sensor, an acceleration sensor, etc. and the distance from an object, the location of the object, etc. are calculated using the AR sensor 313. When a Lidar, a radar, an ADAS mounted on a vehicle cannot be used, the AR sensor acquires roll, pitch, and yaw values of the vehicle by acquiring ground truth-based road mapping information from a camera installed at the front of the vehicle.

Describing this configuration in detail, the AR location module 312 mounted on the vehicle calculates X and Y coordinates that are location information in a plane coordinate system from location information in a spherical coordinate system on the basis of information acquired from the GPS and RTK. As described above, location information is not acquired from any one of the GPS and RTK and location information is acquired from two modules, whereby roll, pitch, and yaw values of the vehicle are acquired.

A process of converting spherical coordinates that are GPS coordinates into plane coordinates that are navigation coordinates is as follows.

First, GPS coordinates are converted into first coordinates and the first coordinates are converted into second coordinates. Thereafter, the second coordinates are converted into camera coordinates. For example, the first coordinates may be Earth-centered Earth-fixed (ECEF) coordinates and the second coordinates may be ENU coordinates that are navigation coordinates.

An objective of the present disclosure is to output additional information such that the additional information is matched to POI objects using an information output device installed in a vehicle that is moving. In relation to the present disclosure, a vehicle does not maintain a fixed location and the posture depends in the state of a road, the driving direction, the driving speed, etc., and accordingly, the relative coordinates of POI objects seen from the objects are changed. Accordingly, the present disclosure calculates camera coordinates of POI objects considering the posture of a vehicle and outputs additional information in consideration of the calculated camera coordinates of the POI objects. The camera coordinates described in the present disclosure are the coordinates of POI objects to which additional information seen through a camera is matched.

Hereafter, a method of converting second coordinates into camera coordinates is described. A camera projection matrix is multiplied by a second coordinate vector is multiplied to convert second coordinates into camera coordinates. As the result of multiplying a camera projection matrix with a second coordinate vector, a vector [v0, v1, v2, v3] is obtained. Thereafter, x=(0.5+v0/v3)*widthOfCameraView and y=(0.5−v1/v3)*heightOfCameraView. The second coordinate vector is [n -e u 1] and the camera projection matrix is the result of product of an original camera projection matrix and a rotation matrix. The camera projection matrix is as follows.

$$[ \begin{matrix}{tan}^{-} ( \frac{FOVx}{2} ) & 0 & 0 & 0 \\ 0 & {tan}^{-} ( \frac{FOVy}{2} ) & 0 & 0 \\ 0 & 0 & - \frac{{Z}_{Far} + {Z}_{Near}}{{Z}_{Far} - {Z}_{@ ar}} & - \frac{2 ( {Z}_{Near} {Z}_{Far} )}{{Z}_{Far} - {Z}_{Near}} \\ 0 & 0 & - 1 & 0\end{matrix} ]$$

The rotation matrix can be acquired from a sensor mounted in the vehicle. The present disclosure converts GPS coordinates into navigation coordinates and then converts the navigation coordinates into camera coordinates.

An AR 3D mapping module 322 recognizes the configuration of the ground on the basis of ground truth. Further, the AR 3D mapping module 322 recognizes the main shapes around a road using an AI-based object classification technique. For example, the AR 3D mapping module 322 recognizes lanes, sidewalks, signs, characters, surrounding vehicles, people, and motorcycles, etc.

Hereafter, a method of recognizing a surrounding space by classifying objects using AI is briefly described.

Vision is a fundamental Software Development Kit (SDK) required for the AR engine described in the present disclosure. Vision enables camera arrangement, object detection/classification/separation, lane feature extraction, and other interfaces.

Vision accesses real-time inference that is performed in Vision core. Vision AR is an add-on module for Vision that is used to implement a customized AR. The Vision AR visualizes a path of a user such as a lane material, a lane geometry, occlusion, a user designation object, etc. Vision safety is an add-on module for a vision that is used to create customized warnings for overspeed, surrounding vehicle, bicycle users, pedestrians, lane departure, etc.

Vision core described above is a core logic of a system including all machine learning models, and when Vision is brought to a project, Vision core is automatically provided.

An AR 3D space module 323 maps the actual location of a vehicle to a 3D geographic information using space recognition acquired through AI and a 3D geographic information mashup service. Describing this process in detail, an accurate heading value of a vehicle is calculated from an image taken by a front camera positioned at the front of the vehicle and the real-time location of the vehicle is corrected using the location coordinates of surrounding main objects. To this end, the AR 3D space module 323 stores location information of main objects (signs, traffic lights, etc.) on the driving path of a vehicle. An intersection, a divergence point, etc. are included as main points of a heading value.

The actual location of a vehicle is estimated from an image taken by a camera installed on the vehicle on the basis of the mapped 3D geographic information and additional information of POI objects are recognized in advance on the basis of pre-loaded data within a camera recognition range such that the additional information can be immediately output in rendering when the vehicle passes corresponding locations.

The AR rendering/object managing module 330 performs AR rendering and manages objects. When a standardized location recognition icon is output, AR rendering provides low polygon- or high polygon-shaped 3D POI information, depending on whether the brand and premium of a user have been registered to be able to attract curiosity of the user. The object managing module designates ID having a name that is a peculiar word combination to each topographical indicator of 3×3 meters and manages metadata for each of the IDs. The AR mapping module maps additional information to POIs in accordance with the type of display outputting the additional information. The AR mapping module includes an AR warping module 321, an AR 3D mapping module 322, and a 3D space mapping module 323.

That is the AR mapping module includes an AR warping module, an AR 3D mapping module, and a 3D space mapping module, and further includes a 3D object management module 324.

An AR platform includes various types of display module. The display module may be implemented in various types such as an AR HUD view module 331, an AR overlay view module 332, an AR camera view module 333, etc. Further, the AR rendering/object managing module 330 includes an AR view management module 334 that manages an AR view.

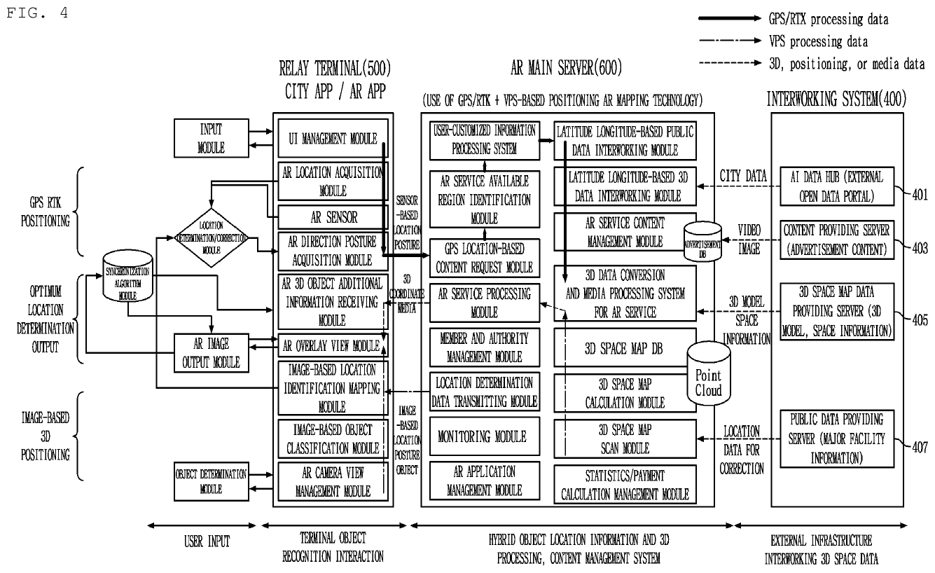

FIG. 4 is an example configuration diagram of the AR service system according to an embodiment of the present disclosure. Hereafter, an AR service system according to an embodiment of the present disclosure is described in detail with reference to FIG. 4.

The AR service system includes a relay terminal 500, an AR main server 600, and an interworking system 400. Of course, components may be included in the AR service system described herein other than the components described above.

The relay terminal 500 may be installed on a vehicle or may be implemented in a terminal type. For example, the relay terminal is connected to a sensor that can collect various items of information, or is included therein when it is a built-in component.

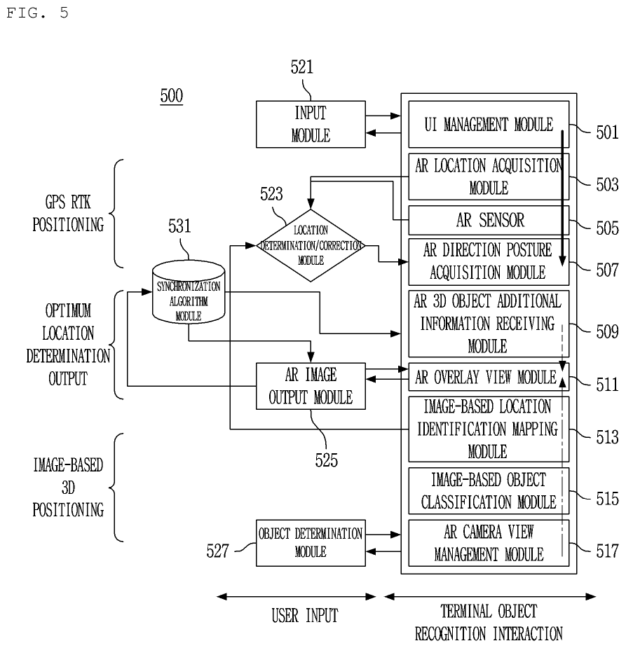

The relay terminal 500 performs positioning using the GPS or RTK and determines the optimum location (posture) of the vehicle equipped with the relay terminal 500. Further, the relay terminal 500 performs image-based 3D positioning using images collected from a camera. The detailed functions of the relay terminal 500 will be described with reference to FIG. 5.

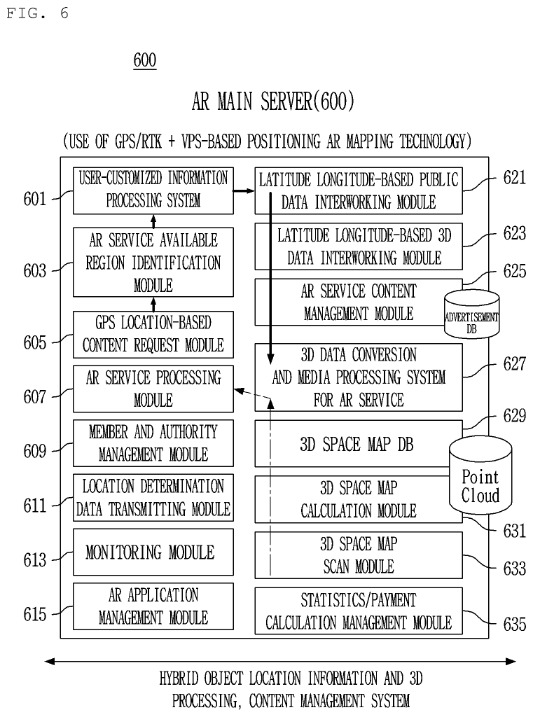

The AR main server 600 performs the function of mapping a location calculated using a GPS or RTK or a Visual Positioning Service (VPS)-based location using images collected from a camera to AR 3D. The detailed operation of the AR main server will be described with reference to FIG. 6.

The interworking system 400 is connected to the AR main server 500 and provides required data or information to the AR main server 500. The interworking system 400 may include an AI data hub (external open data portal) 401, a content providing server (advertisement content) 403, a map data providing server (3D model, space information) 405, and a public data providing server (major facility information) 407. The AI data hub 401 provides city data to the AR main server and the content providing server 403 provides a video/image to the AR main server. Further, the 3D space map data providing server 405 provides 3D modeling map data to the AR main server and the public data providing server 407 provides data about major facilities (streetlamps, traffic lights, etc.) that are location data for correction to the AR main server.

FIG. 5 shows the configuration of a relay terminal according to an embodiment of the disclosure. Hereafter, the configuration of a relay terminal according to an embodiment of the present disclosure is described in detail with reference to FIG. 5.

As described above, a relay terminal is divided into a configuration that performs positioning using the GPS or RTK, a configuration that corrects a location using an image, a configuration that performs 3D mapping, and a configuration that determines and outputs an optimum location of a vehicle. Hereafter, the configurations are sequentially described.

Input module 521 inputs device information or member information and registers functions related to application setting.

UI manager (management) module 501 manages a service for AR information linkage and a user ID. The UI management module 501 manages a user or supports a service in accordance with information input through the input module. Of course, the UI management module 501 supports an UI such that the UI can input required information to the input module 521.

AR location acquisition module 503 acquires a latitude/longitude according to whether the GPS or RTK is connected or connection thereof. AR sensor 505 includes an acceleration sensor, a gyro sensor, a compass, or the like and acquires the direction, speed, acceleration, etc. of the vehicle equipped with the relay terminal.

The information acquired through the AR location acquisition module 503 and the AR sensor 505 is provided to a location determination/correction module 523. The location determination/correction module 523 determines the latitude and longitude of a vehicle by determining priority in order of GPS, RTK, or VPS. Of course, the location determination/correction module 523 determines the latitude and longitude of a vehicle by being provided with feature points (VPS) of objects mapped in an image-based location identification mapping module to be described below.

AR direction posture acquisition module 507 acquires direction and posture information of the vehicle using the latitude and longitude of the vehicle determined by the location determination/correction module 503. That is, the AR direction posture acquisition module 507 acquires direction and posture information of the vehicle using information collected from a gyro sensor, an acceleration sensor, an Inertial Measurement Unit (IMU), or the like.

Object determination module 527 determines objects such as a road, a sidewalk, a store, a building, or the like from an image obtained from a camera. AR camera view management module 517 creates parameters for converting the field of view (FOV) of a camera for providing an AR image and AR camera, that is, real world camera image coordinates into camera coordinates in a 3D space, and maps 3D coordinates in a digital twin/mirror environment.

An image-based object classification module 515 classifies objects such as a road, a sidewalk, a crosswalk, a sign, a person, and a vehicle.

The image-based location identification mapping module 513 receives/downloads data within a radius defined on the basis of a latitude/longitude for point cloud information stored in an AR server, stores the data in a device memory, and maps a camera input image and feature points in real time. That is, the image-based location identification mapping module 513 maps feature points of signs, traffic lights, and crosswalks classified in an image input from a camera to feature points of objects stored in advance.

AR local cashing synchronization algorithm module 531 determines synchronization through comparison with AR main server data on the basis of AR mapping data within a predetermined radius or stored on the basis of a predetermined region.

AR 3D object additional information receiving module 509 receives and stores 3D and media data including additional information from the AR main server in a local storage, and loads additional information such that the additional information can be displayed on an AR image.

AR overlay view module 511 combines and outputs 3D and media data in accordance with a location position that is changed in accordance with the FOV of a camera and the position of an information output device.

AR image output module 525 outputs together an overlay view, a UI, and a map combined with content.

As described above, the present disclosure provides a method of outputting additional information such that the additional information is accurately matched to objects in consideration of the location and posture of a vehicle.

FIG. 6 shows the configuration of an AR main server according to an embodiment of the present disclosure. Hereafter, the configuration of an AR main server according to an embodiment of the present disclosure is described in detail with reference to FIG. 6.

GPS location-based content request module 605 makes a query for a location-based data request of AR content that will be provided on the basis of a GPS location and direction data requested from the relay terminal.

AR service available region identification module 603 checks public data or 3D data based on the query made by the GPS location-based content request module 605, thereby checking whether it is a region in which information based on latitude/longitude/direction is fundamentally provided and whether it is a region in which VPS-based information can be additionally provided.

User-customized information processing system 601 sets a data filtering condition in accordance with service setting by a user on the basis of various items of POI information based on public data and 3D data.

Latitude/longitude-based public data interworking module 621 collects relevant data according to a personalization filter condition from public data (road and crosswalk information, etc.) and arranges of relevant data as transmission data.

Latitude longitude-based 3d data interworking module 623 collects city data from an AI data hub such as a 3D building and applies the city data to a 3D map to implement a location-based 3D on an AR image.

AR service content management module 625, which is a system that manages AR service content, performs functions of registering, editing/deleting/searching/file uploading/downloading media data to be provided to an internal server (or an information output device).

3D space map scan module 633 extracts feature points on the basis of a panorama image secured for an actual place when a location is determined on the basis of vision, and stores the feature points in a server.

3D space map calculation module 631 stores feature points within a 3D space in a point cloud library (PCL) through the location relationships of feature points moved on the basis of the extracted feature points.

3D space map DB 629 constructs a 3D space map by precisely mapping the stored PCL to the latitude/longitude locations in the real world, whereby the 3D space map is used for image- based location tracking.

Location determination data transmission module 611 transmits the PCL for a camera- based VPS of the internal server (or information output device) to each data section.

3D data conversion and media processing system for an AR service 627 prepares data on the basis of a 3D model and space information from a digital twin (mirror world data) such as a 3D building for 3D processing on an AR image.

AR service processing module 607 transmits augmented street/signage/facility/message data in accordance with UI layer service setting requested from a device.

Further, the AR main server 600 includes a member and authority management module 609, a monitoring module 613, or a management module 635.

Although the present disclosure has been described with reference to the exemplary embodiments illustrated in the drawings, those are only examples and may be changed and modified into other equivalent exemplary embodiments from the present disclosure by those skilled in the art.

The present disclosure relates to a vehicle AR display device and method and an AR service platform and, more particularly, to a method of outputting additional information of object photographed by a camera mounted on a vehicle such that the additional information is matched to the objects.

The vehicle AR display device and the AR service platform according to the present disclosure can perform precise positioning and create a map for autonomous driving composed of minimum metadata using a vehicle that has been being operated without an exclusive vehicle for precision positioning or a 3D point cloud. Further, since when a transportation means is a car and is moved every day, a map is updated every day, whereby it is possible to secure reliability of data.

1. An AR service platform system comprising:
a relay terminal configured to calculate a location, a direction, or a posture of a vehicle using information collected from a positioning sensor or a camera, extract POI objects included in an image acquired from the camera, and perform control such that additional information for the extracted POI objects is output and matched to the extracted POI objects; and
an AR main server connected to the relay terminal and configured to extract and provide additional information for POI objects included in information collected from the camera to the relay terminal.

2. The AR service platform system of claim 1, wherein the relay terminal receives additional information for POI objects, which are included in an image acquired from the camera, from the AR main server before extracting POI objects from the camera.

3. The AR service platform system of claim 1, wherein the AR service platform system classifies any one of a road, a sidewalk, a crosswalk, a sign, a person, and a vehicle from an image that is received.

4. The AR service platform system of claim 1, wherein the relay terminal converts a field of view of the camera and a real world camera image coordinates into camera coordinates in a 3D space to provide an AR image.

5. The AR service platform system of claim 4, wherein the AR service platform system combines and outputs 3D and media data in accordance with camera coordinates that change in accordance with an angle of view of the camera and a location of an information output terminal configured to output additional information.

6. The AR service platform system of claim 1, wherein the AR main server extracts and stores feature points on the basis of a panorama image taken by the camera.

7. The AR service platform system of claim 1, wherein the AR main server stores feature points in a 3D space in a point cloud library (PCL) through location relationships of feature points moved on the basis of the extracted feature points.

8. The AR service platform system of claim 1, wherein the relay terminal acquires a location of the vehicle from a GPS or RTK and acquires a direction of the vehicle from an acceleration sensor or a gyro sensor.

9. The AR service platform system of claim 8, wherein the relay terminal acquires a location or a posture of the vehicle by comparing feature points of objects on a driving path acquired from an image taken by the camera with stored feature points of objects.
